(19) United States
(12) Patent Application Publication
(10) Pub. No.: US 2004/0056492 A1
(43) Pub. Date: Mar. 25, 2004

(54) Reaching apparatus kit and method of using same

(76) Inventor: Robert S. Traber, Escondido, CA (US)

Correspondence Address: JERRY RICHARD POTTS, 3248 VIA RIBERA, ESCONDIDO, CA, 92029, US

(21) Appl. No.: 10/252,313

(22) Filed: Sep. 23, 2002

(51) Int. Cl. B25J 1/00

(52) U.S. Cl. 294/19.1; 294/100

(57) ABSTRACT

A modification kit for a reaching tool having a pair of elongated flexible spring fingers pivotally secured to a shaft and adapted to move toward one another to facilitate grasping an object includes a cuff having a sufficient interior space to receive and support therein a substantial portion of the spring fingers so as to constrain their outward lateral movement when they are moved towards one another for engaging an object thereby substantially increasing the weight load capacity of the reaching tool.

### BACKGROUND OF THE INVENTION

1. Field of the Invention

This invention pertains to the field of hand-actuated tools. More particularly, this invention pertains to the field of single-hand actuated pick-up tools that are used by those who have difficulty reaching and fetching objects, such as bottles, plates, shoes, and the like, and to a specific tool modification kit that substantially increases the weight load capacity of the pick up tool.

2. Description of the Prior Art

The reaching tool modification kit employs a conventional pick up tool that comprises an elongated stalk with a pair of flexible fingers diverging from the far or distal end of the stalk. A pair of rubber cups is attached one to the end of each finger. A center strap is connected to the fingers and is directed in through the interior of the stalk to a handle at the other end and has a squeezable trigger at the inner or proximal end. By squeezing the trigger, the cups are made to close onto or around an object being picked up by the holder of the tool.

This conventional pick up tool was first patented in the U.S. Pat. No. 3,527,492 and still is in production, enjoying great commercial acceptance and significant sales. Those who are infirm and require aid in reaching and gathering objects of all types use it. Further, persons who clean our parks and roadways of trash and debris use it. Young and old use it alike and its use is expected to continue for many years.

It is believed the popularity of this device is supported in large part by the fine design and craftsmanship that goes into its manufacture. The center stalk is made of lightweight aluminum; its handle is formed from strong injection molded plastic and the fingers, center strap, and fittings are made of first-class stainless steel. This tool has a lifetime warranty and will not break, even under heavy and harsh usage.

There is also a less expensive version of the tool which is also still in production and that was first patented in U.S. Pat. No. 5,577,785. Like its predecessor, this less expensive tool has also enjoyed great commercial acceptance with significant sales.

While both pick up tools are popular and well accepted in the community, there is however, an area of daily life where such tools are required from time to time to grasp and move much heavier objects. Therefore it would be highly desirable to have a new and improved tool modification kit that enables much heavier objects to be grasped and moved that otherwise would be impossible to move with the tools described in the above-mentioned patents.

### SUMMARY OF THE INVENTION

This invention is a modification kit that enables the devices disclosed and claimed in the aforesaid patents to grasp and move with ease significantly heavier objects that would not otherwise be able to be moved by such reaching tools. More particularly, in a first embodiment the modification kit includes a plastic molded constraining cuff that is adapted to be secured to a reaching tool. The kit includes right portion cuff with tabs along it longitudinal edge and a left portion cuff with slots along its longitudinal edge. The tabs are dimensioned to be received within the slots and to snap into place, locking the two portions together when the halves are mounted to the distal end of the reaching tool to constrain the spring finger of the tools from excessive bowing when the tool is utilized to grasp a heavy object. To further secure the right portion and the left portion together the tabs are coated with a fast acting adhesive that bonds the tabs within the slots.

In a second embodiment a modification kit includes a constraining cuff that is adapted to be secured to a reaching tool having an elongated stalk with a pair of flexible fingers diverging from the far or distal end of the stalk. The constraining cuff includes a plurality of inwardly projecting positioning bosses that enable the constraining cuff to be aligned and held in place on the distal end of the tool so as to reduce significantly the outward bowing of the flexible fingers when they engage and hold an object for moving purposes.

A third embodiment includes a metallic constraining cuff that is adapted to be secured to a reaching tool having an elongated shaft with a pair of flexible jam members diverging from the distal end of the shaft. The modification kit also includes a plurality of positioning pins that enable the cuff to be aligned and held in place on the distal end of the reaching tool shaft so as to constrain the outward bowing of the jaw members when they engage and hold an object for moving purposes.

A fourth embodiment includes a flat sheet of plastic material having a set of snap hook that enable the sheet to be formed into a funnel shaped constraining cuff that is adapted to be aligned and secured to the distal end of a reaching tool. A pair of alignment pins facilitates attaching the cuff to the reaching tool. When so aligned and secured to the reaching tool, the constraining cuff substantially reduces the outward bowing of the flexible spring member when they engage and hold an object for moving purposes. In accordance with the novel method of using the kit, the constraining cuff is aligned and attached to the reaching tool and the actuating means of the tool is engaged to facilitate substantially increasing the load or weight lifting capacity of the tool

### BRIEF DESCRIPTION OF THE DRAWINGS

The above mentioned features and steps of the invention and the manner of attaining them will become apparent, and the invention itself will be best understood by reference to the following description of the embodiments of the invention in conjunction with the accompanying drawings wherein:

FIG. 1 is a perspective view of a preferred embodiment of a reaching apparatus kit, which is constructed in accordance with the present invention;

FIG. 2 is a perspective view of the reaching apparatus kit of FIG. 1, showing it in an assembled form;

FIG. 3 is a perspective view of another preferred embodiment of a reaching tool kit, which is constructed in accordance with the present invention;

FIG. 4 is a perspective view of the reaching tool kit of FIG. 3, showing it in an assembled form;

FIG. 5 is a trimetic view of yet another preferred embodiment of a reaching apparatus kit, which is constructed in accordance with the present invention;

FIG. 6 is a perspective view of the reaching apparatus kit of FIG. 5, showing it in an assembled form;

FIG. 7 is a perspective view of a constraining cuff forming part of the reaching apparatus kit of FIG. 5, showing the cuff in its unassembled form;

FIG. 8 is an enlarged perspective view of a constraining cuff of FIG. 6, showing it in its assembled form;

FIG. 9 is an enlarged perspective view of the constraining cuff of FIG. 6, showing its positioning pins for securing the cuff to a reaching tool;

FIG. 10 is a top plan view of the reaching apparatus of FIG. 1, showing its flexible finger members being constrained;

FIG. 11 is a top plan view of a prior art reaching apparatus showing its flexible finger members in an unconstrained position;

FIG. 12 is a top plan view of the reaching tool of FIG. 3, showing its flexible finger members being constrained;

FIG. 13 is a top plan view of a prior art reaching apparatus showing its flexible finger members in an unconstrained position;

FIG. 14 is a top plan view of the reaching tool of FIG. 5, showing its flexible finger members being constrained;

FIG. 15 is a top plan view of a prior art reaching apparatus showing its flexible finger members in an unconstrained position;

FIG. 16 is a top plan view of a constraining cuff, which is constructed in accordance to the present invention;

FIG. 17 is a top plan view of a prior art reaching apparatus showing its flexible finger members in an unconstrained position;

FIG. 18 is a trimetic view of still yet another preferred embodiment of a reaching apparatus kit, which is constructed in accordance with the present invention; and

FIGS. 19-21 are the illustrative steps of securing the constraining cuff of FIG. 18 to a reaching tool.

### DESCRIPTION OF THE PREFERRED EMBODIMENTS

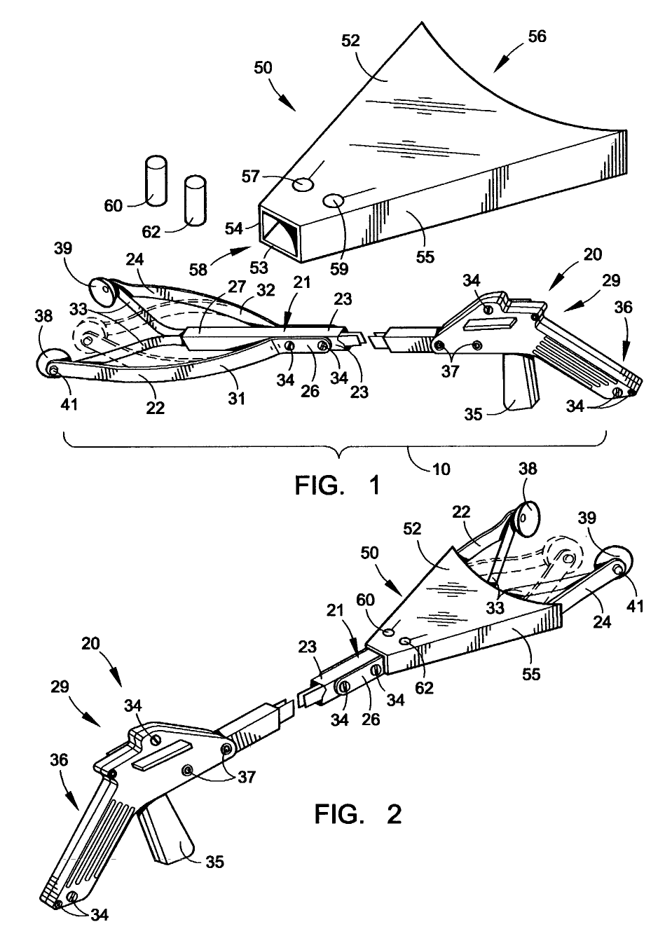

Referring now to the drawings and more particularly to FIGS. 1-2 thereof there is shown a first preferred embodiment of a reaching tool modification kit 10, which is constructed in accordance with the present invention. The reaching tool modification kit 10, when assembled and utilized in accordance with the novel method of the present invention, substantially increases the weight or lift capacity of a conventional reaching tool as will be described hereinafter in greater detail.

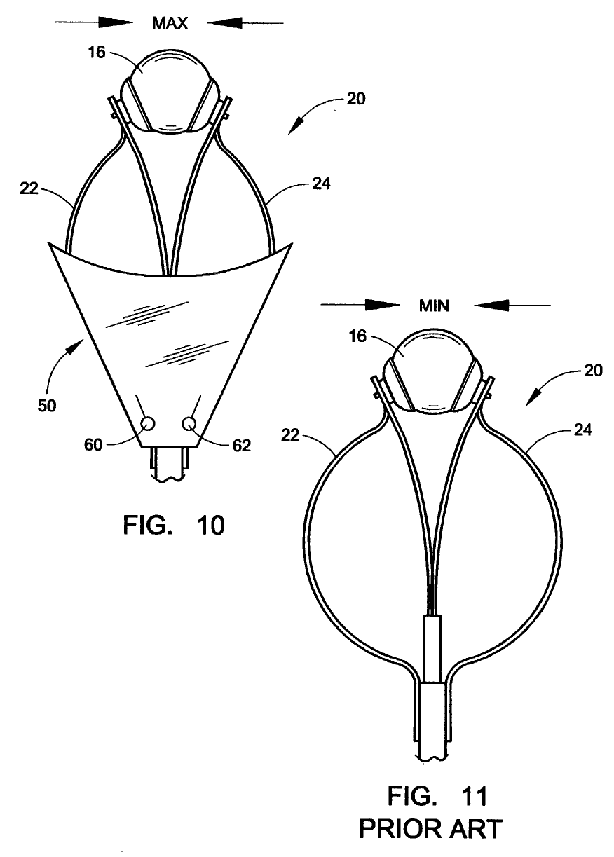

Considering now the reaching tool modification kit 10 in greater detail with reference to FIGS. 1-2, the reaching tool modification tool kit 10 generally includes a reaching tool 20 having a pair of flexible spring pick-up fingers 22 and 24 and a constraining cuff 50 which is adapted to be aligned and secured to a distal end portion of the reaching tool 20 by a pair of positioning pins 60 and 62 respectively. In accordance with the novel method of using the kit 10 to modified the reaching tool 20, the constraining cuff 50 is mounted to the distal end of the reaching tool 20 and aligned with its shaft and flexible fingers 22 and 24 to substantially reduce the outward bowing of the flexible finger members 22 and 24 when they are drawn together in a gripping position about an object 16 as best seen in FIG. 10. FIG. 11 shows a conventional prior art reaching tool 20, without a constraining cuff, illustrating how its flexible spring pick-up fingers 22 and 24 bow significantly outward as an object 16 is grasped.

As best seen in FIG. 1 the reaching tool 20 generally comprises an elongated hollow stalk 21, made up of sedewalls 23 attached together along their respective side edges to form a rectangular, cross sectional hollow member made of thin-walled, extruded aluminum terminated at spaced-apart distal and proximal ends 27 and 29, respectively. The flexible, spring pick-up fingers 22 and 24 each include a straight portion, such as a straight portion 26 that is dimension to facilitate mounting or attaching the proximal ends of the fingers 22 and 24 to the outside of stalk 21 by screws 34. The fingers 22 and 24 further include intermediate portions 31 and 32 respectively that bow outwardly from the stalk 21 and then extend forward terminating at their distal ends in a pair of flexible elements or cups 38 and 39 which are attached by a post and nut combination 41.

A center strap 33 extends from each cup, such as the cup 39 through the interior of stalk 21 to a trigger 35 that is pivotally mounted at stalk proximal end 29 and is adapted to pull center strap 33 rearward when squeezed as part of a handle 36 formed thereabout at stalk proximal end 29. The rearward pull of center straps 33 causes cups 38 and 39 to come together for grasping an object by flexing and bending pick-up fingers 22 and 24 toward each other. Handle 36 is made up of two injection-molded, half-handles that are attached together and to stalk 21 by numerous rivets 37 and screws 34.

As shown, this reaching tool 20 is made up of numerous special parts, molded or cut from metal and plastic that require intensive labor to assemble. Accordingly, this device carries a rather large price tag and is so strong it can support a lifetime warranty given to it by the manufacturer.

Considering now the constraining cuff 50 in greater detail with reference to FIG. 2, the constraining cuff 50 has a unitary construction that is generally triangular or funnel shaped consisting of a top wall member 52, a bottom wall member 53 and a pair of sidewall members 54 and 55 respectively. The wall members 52-55 cooperate to define a large open front mouth or opening indicated generally at 56, and a narrow rectangularly shaped rear mouth or opening indicated generally at 58. The rear opening 58 is dimensioned to engage the straight portions 26 of the reaching tool 20 in a snug friction tight fit with a substantial portion of the intermediate members 31 and 32 abutting against 54 and 55 respectively.

The top wall member 52 and the bottom wall member 53 each include a pair of pin mounting holes, such as pin mounting holes 57 and 59 respectively. The pin mounting holes in the top wall member 52 are in alignment with the pin mounting holes in the bottom wall member 53 and are disposed forward of the rear opening. With the pin mounting holes 57 and 59 aligned relative to the stalk 21 and the intermediate portions 26 and 28 the constraining cuff 50 is secured to the reaching tool utilizing the positioning pins 60 and 62 that are dimensioned to be received in a friction tight fit within the pin mounting holes 57 and 59.

Considering now the novel method of modifying and using the reaching tool modification kit 10, a user first removes the spring fingers 22 and 24 from the reaching tool 20 by removing their mounting screws 34. With the spring fingers 22 and 24 removed from the shaft 21, the proximal ends of the spring fingers 22 and 24 respectively are then inserted through the front opening 56 of cuff 50 a sufficient distance so their proximal straight end portions 26 emerge from the rear mouth 58. The user then aligns the mounting holes on the straight portions 26 with the mounting holes on the distal end of the stalk 21. When so aligned the user reattaches the straight portions 26 to the stalk 21 using the mounting screws 34. With the constraining cuff 50 so positioned on the reaching tool 20, the user next attaches the cuff 50 to the reaching tool 20 by inserting the positioning pins 60 and 62 in a friction tight fit within the pin mounting holes 57 and 59 respectively.

According to the novel method of using the reaching tool modification kit 10, the reaching tool 20 with the constraining cuff 50 secured thereto is then brought into proximity of a heavy object 16. The user then actuates the trigger 35 drawing the spring fingers 22 and 24 into engagement with the object 16. The user then moves the object 16 so grasped between the cups 38 and 39 to a desired position and then releases the trigger 35, which in turn, allows the spring fingers 22 and 24 to move away from one another releasing the object 16.

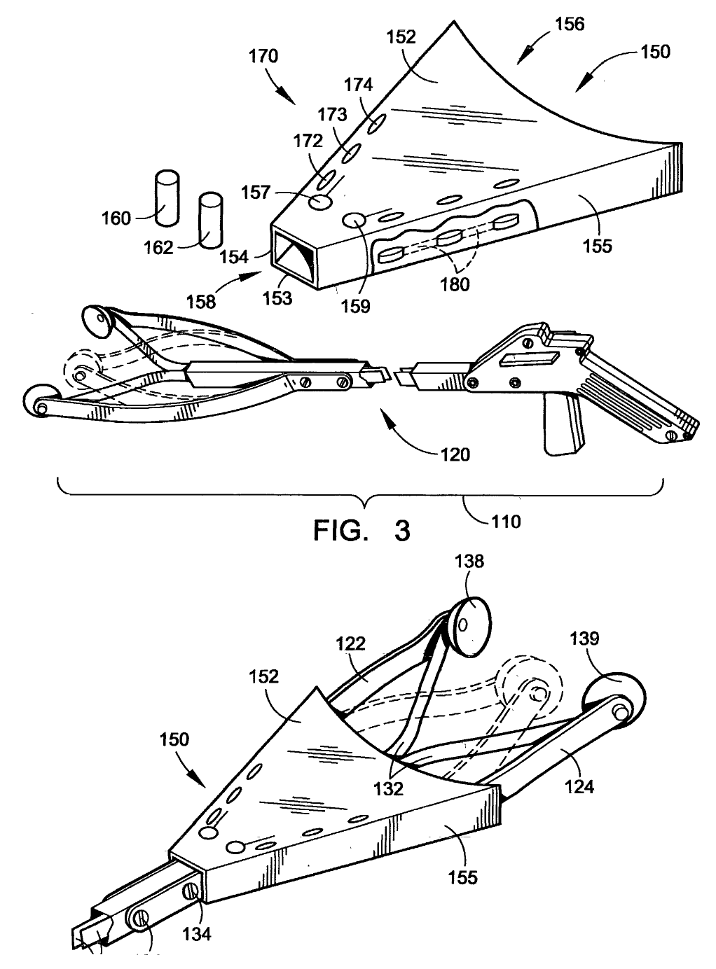

Referring now to the drawings and more particularly to FIGS. 3-4, there is shown a second preferred embodiment of a reaching tool modification kit 110, which is constructed in accordance with the present invention. The reaching tool modification kit 110, when assembled and utilized in accordance with the novel method of the present invention substantially increases the weight or load capacity of a conventional reaching tool as will be described hereinafter in greater detail.

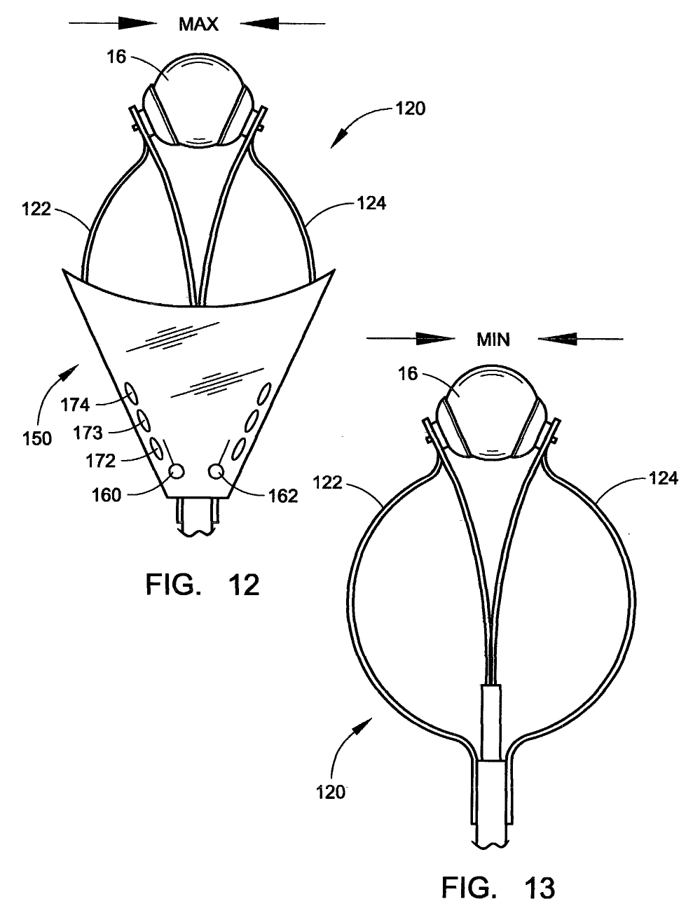

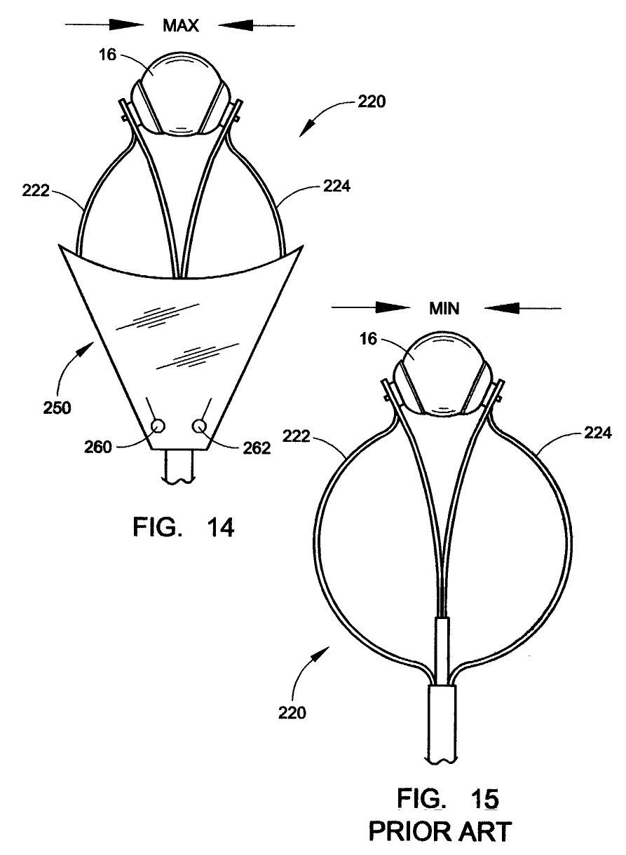

Considering the reaching tool modification kit 110 in greater detail with reference to FIGS. 3-4, the reaching tool modification tool kit 110 generally includes a reaching tool 120 having a pair of flexible spring pick-up fingers 122 and 124 and a constraining cuff 150 which is adapted to be aligned and secured to a distal end portion of the reaching tool 120 by a pair of positioning pins 160 and 162 respectively. In accordance with the novel method of using the kit 110 to modified the reaching tool 120, the constraining cuff 150 is mounted to the distal end 127 of the reaching tool 120 and aligned to substantially reduce the outward bowing of the flexible finger members 122 and 124 when they are drawn together in a gripping position about an object 16 as best seen in FIG. 12.

Considering now the reaching tool 120 in greater detail with reference to FIGS. 3-4, the reaching tool 120 includes a center strap 132 is reversed bent at its center and is brought back out through the stalk distal end 127 to the distal ends of the two pick up fingers 122 and 124. The ends of the center strap 132 are riveted to the distal ends of the pick up fingers 122 and 124 and to cups 138 and 139 respectively. As a detailed description of the construction of the reaching tool 120 is provided in U.S. Pat. No. 5,577,785 no further description of the reaching tool 120 will be provided herein. U.S. Pat. No. 5,577,785 is incorporated herein as though fully set forth.

Considering now the constraining cuff 150 in greater detail with reference to FIG. 3, the constraining cuff 150 has a unitary construction that is generally triangular or funnel shaped consisting of a top wall member 152, a bottom wall member 153 and a pair of sidewall members 154 and 155 respectively. The wall members 152-155 cooperate to define a large open front mouth indicated generally at 156 and a narrow rectangularly shaped rear opening indicated generally at 158. The rear opening 158 is dimensioned to engage the reaching tool shaft 121 in a snug friction tight fit with a substantial portion of the fingers 113 and 115 abutting against sidewalls 154 and 155. The top wall member 152 and the bottom wall member 153 each include a pair of pin mounting holes, such as pin mounting holes 157 and 159 respectively. The pin mounting holes in the top wall member 152 are in alignment with the pin mounting holes in the bottom wall member and are disposed forward of the rear opening 158 a sufficient distance to be positioned in a perpendicular alignment axis that extends between the stalk 121 and respective ones of the fingers 122 and 124. With the pin mounting holes 157 and 159 so aligned relative to the stalk 121 and the fingers 122 and 124 the constraining cuff 150 is secured to the reaching tool 120 utilizing the positioning pins 160 and 162. The positioning pins 160 and 162 are dimensioned to be received within the pin mounting holes 157 and 159 in a friction tight fit.

As best seen in FIG. 3, the top wall member 152 includes a pair 170 of a plurality of staggered boss members that extend forward of the rear opening 158 and adjacent respective ones of the sidewall members 154 and 155. Each plurality of stagger boss members includes at least three boss members, such as the boss members 172, 173 and 174. Each of the boss members 172-174 extends inwardly into an interior portion of the constraining cuff 150 a sufficient distance to function as an interior restraining wall.

As best seen in the cutaway view of FIG. 3, the bosses extend down from the top wall 152 and extend up from the bottom wall 153 and cooperate to form an interior wall, such as a wall indicted generally at 180. In this regard, the lateral distance between this interior restraining wall 180 and its adjacent sidewall is sufficiently wide to capture therebetween one of the flexible spring fingers. Thus for example, the spring finger 122 is captured between sidewall member 155 and its associated interior restraining wall 180 to limit the amount of bowing in the spring finger 122 when it distal end engages an object 16 for grasping and moving purposes. The constraining of the flexible fingers 122 and 124 enable the reaching tool 120 to pick-up significantly heavier object while utilizing lighter materials for the flexible fingers. In this regard, by utilizing lighter weight finger material, not only is the cost of producing the reaching tool 120 reduced, but also it reduces the amount of force required to pull the trigger 135 on lighter objects, such as cigarette butts and paper trash. This benefits the user by reducing the hand fatigue involved with repeated usage, which is a significant advantage for roadside maintenance workers.

The novel method of modifying and using the reaching tool modification kit 110, is substantially the same as described for kit 10 except for the method of inserting the spring fingers 122 and 124 through the cuff 150. In this regard, the straight and intermediate portions of each respective one of the spring fingers 122 and 124 are positioned against the interior of the sidewalls 154 and 155 respectively allowing them to be captured between the boss walls, such as the wall 180 and their respective sidewalls. The straight portions are attached to the stalk 121 with screws 134 after they are extended out of the rear mouth 158 and aligned with the mounting holes on the stalk 121. With the constraining cuff 150 so positioned on the reaching tool 120, the user attaches the cuff 150 to the reaching tool 120 by inserting the positioning pins 160 and 162 in a friction tight fit within the pin mounting holes 157 and 159.

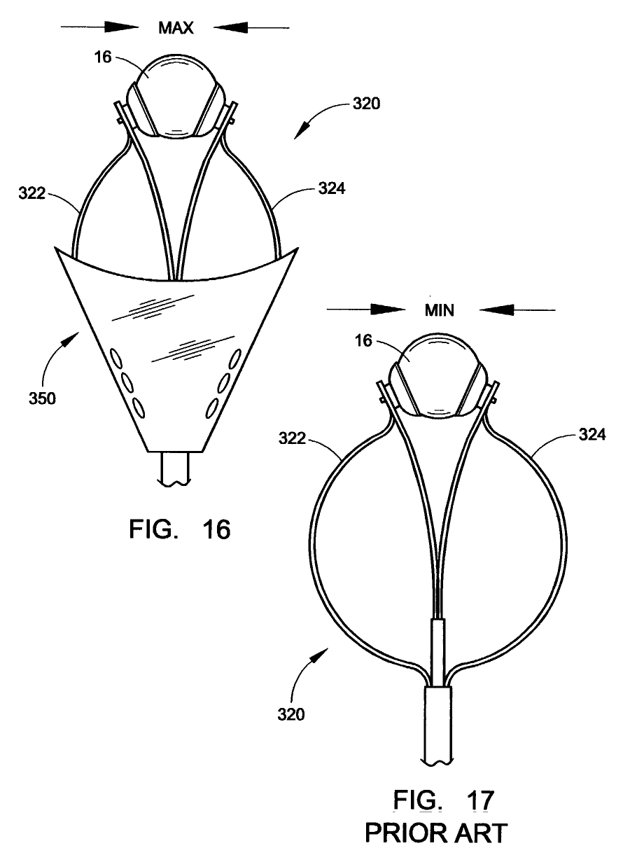

Although in this preferred embodiment of the present invention, the restraining cuff 150 has been describes as being mounted to the reaching tool 120 utilizing the positioning pins 160 and 162, it should be understood by those skilled in the art that the restraining action imparted by the boss members 172-174 and sidewalls of the cuff 150 against the spring fingers 122 and 124 is sufficient to retain the cuff 150 firmly mounted to the reaching tool 120 without the need of utilizing the positioning pins 160 and 162. Thus, for example a restraining cuff 350 as best seen in FIG. 16, and which is constructed in accordance with the present invention, does not include positioning holes for mounting pins.

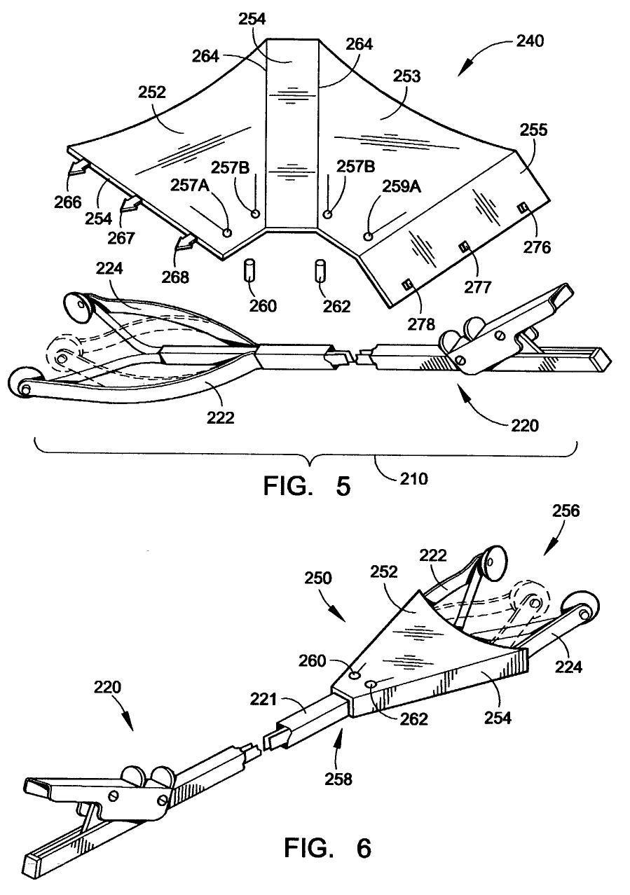

Referring now to the drawings and more particularly to FIGS. 5-6, there is illustrated yet another preferred embodiment of a reaching tool modification kit 210, which is constructed in accordance with the present invention. The reaching tool modification kit 210 when assembled and utilized in accordance with the novel method of the present invention, substantially increases the weight lifting capacity of a conventional reaching tool as will be described hereinafter in greater detail.

Considering the reaching tool modification kit 210 in greater detail with reference to FIGS. 5-6, the reaching tool modification tool kit 210 generally includes a reaching tool 220 having a pair of flexible spring pick-up fingers 222 and 224 and a constraining cuff 250 which is adapted to be aligned and secured to a distal end portion of the reaching tool 220 by a pair of positioning pins 260 and 262 respectively. In accordance with the novel method of using the kit 210 to modified the reaching tool 220, the constraining cuff 250 is mounted to the distal end of the reaching tool 220 and aligned to substantially reduce the outward bowing of the flexible finger members 222 and 224 when they are drawn together in a gripping position about an object 16.

As best seen in FIG. 5 the reaching tool 220 is substantially identical in construction to reaching tool described in U.S. Pat. No. 5,577,785 and therefore the reaching tool 220 will not be described hereinafter in greater detail.

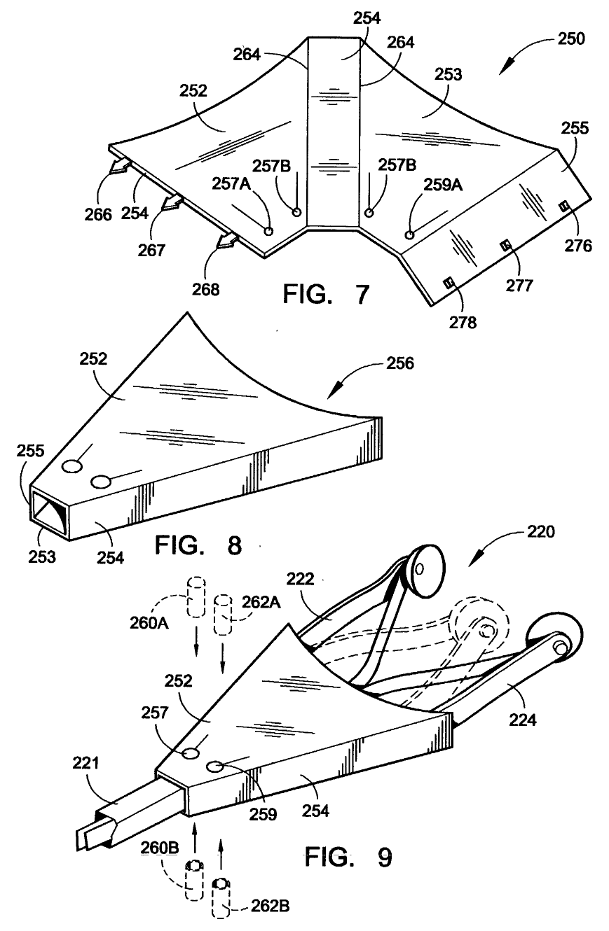

As best seen in FIGS. 5 and 7, the constraining, cuff 250 has a unitary construction and comprises a substantially flat sheet of molded plastic, indicated generally at 240, having a pair of irregular shaped top and bottom wall members 252 and 253 respectively that are integrally connected together by a generally rectangularly shaped sidewall member 254. Sidewall member 254 is joined at its long edge sides by a plastic hinge 264 to respective ones of the top wall member 252 and the bottom wall member 253. The plastic hinge 264 permits the top wall member 252 and the bottom wall member 253 to be pivoted towards one another as will be explained hereinafter in greater detail.

As best seen in FIG. 11, sidewall member 254 has projecting outwardly from a side edge a set of spaced apart snaps 266, 267, and 268 respectively. The snaps 266, 267 and 268 are dimensioned to engage and to snap in place the sidewall member 255 with the bottom wall member 252. In this regard, when the sidewall member 255 is pivoted toward from the top wall member 252 it is secured to the edge of top wall member 252 by engaging a corresponding set of hooks 276-278 disposed in the sidewall member 255 with the snaps 266-268. In this manner, the constraining cuff 250 is formed without the need of using any tools or adhesives.

When so joined as described-above, the wall members 252-255 form a generally funnel shaped enclosure having a large open front mouth indicated generally at 256 and a narrow rectangularly shaped rear opening or mouth indicated generally at 258. The rear opening 258 is dimensioned to engage the reaching tool stalk 221 in a snug friction tight fit with a substantial portion of the spring fingers 222 and 224 abutting against sidewalls 254 and 255. The top wall member 252 and the bottom wall member 253 each include a pair of pin mounting holes, such as pin mounting holes 257 and 259 respectively. The pin mounting holes in the top wall member 252 are in alignment with the pin mounting holes in the bottom wall member and are disposed rearward of the rear opening 258. With the pin mounting holes 257 and 259 aligned relative to the stalk 221 and the spring fingers 222 and 224, the constraining cuff 250 is secured to the reaching tool 220 utilizing the positioning pins 260 and 262 that are dimensioned to be received in a friction tight fit within the pin mounting holes 257A-B and 259A-B.

Considering now the novel method of modifying and using the reaching tool modification kit 210 with reference to FIGS. 7-9, a user first wraps the unfolded sheet 240 around the spring fingers 222 and 224 by pivoting the wall members 252-254 by their respective hinges to form a funnel shaped enclosure. Next the user inserts the snaps 266-268 within respective ones of the hooks 276-278 snapping them together to form the constraining cuff 250. With the constraining cuff 250 so formed, the user next attaches the cuff 250 to the reaching tool 220 by inserting the positioning pins 260 and 262 in a friction tight fit within the pin mounting holes 257 and 259.

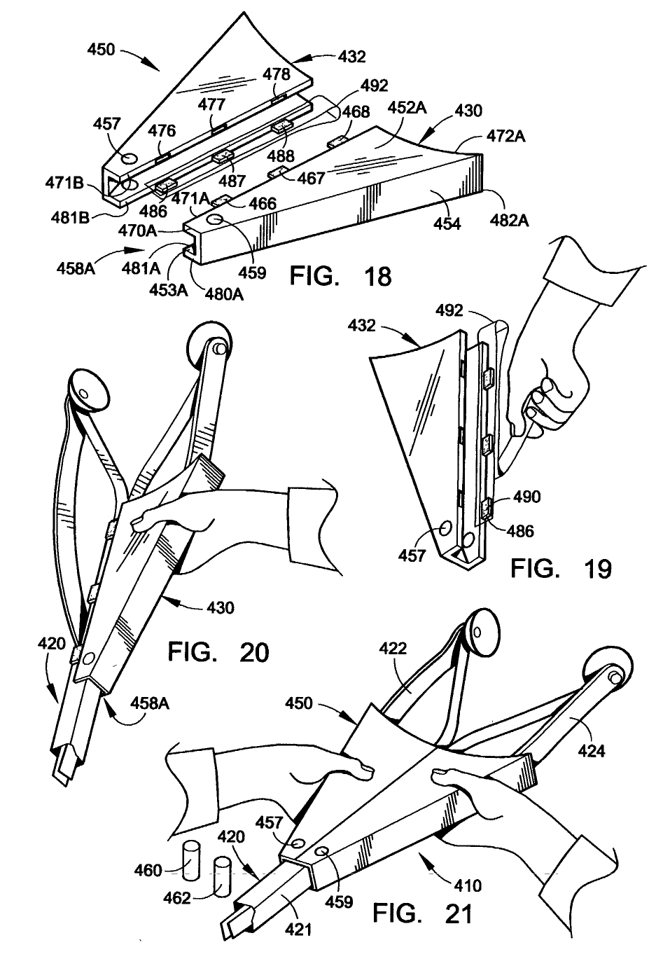

Referring now to the drawings and more particularly to FIGS. 18-21, there is illustrated still yet another preferred embodiment of a reaching tool modification kit 410, which is constructed in accordance with the present invention. The reaching tool modification kit 410 when assembled and utilized in accordance with the novel method of the present invention, substantially increases the weight lifting capacity of a conventional reaching tool as will be described hereinafter in greater detail.

Considering the reaching tool modification kit 410 in greater detail with reference to FIGS. 18-21, the reaching tool modification tool kit 410 generally includes a reaching tool 420 having a pair of flexible spring pick-up fingers 422 and 424 and a constraining cuff 450. The cuff 450 is adapted to be aligned and secured to a distal end portion of the reaching tool 420 as will be described hereinafter in greater detail. In accordance with the novel method of using the kit 410 to modified the reaching tool 420, the constraining cuff 450 is mounted to the distal end of the reaching tool 420 and aligned to substantially reduce or constrain the outward bowing of the flexible finger members 422 and 424 and to channel their weight lifting power when they are drawn together in a gripping position about an object, such as an object 16 seen in FIG. 16.

As best seen in FIG. 21, the reaching tool 420 is substantially identical in construction to reaching tool 220 and therefore the reaching tool 420 will not be described hereinafter in greater detail.

As best seen in FIG. 18, the constraining cuff 450 generally comprises a triangularly shaped right half portion 430 and a triangularly shaped left half portion 432 that are adapted to be joined together in a fixed ridged position to constrain and channel the weight lifting power of the flexible finger member 422 and 424 as will be describer hereinafter in greater detail.

As best seen in FIGS. 18 and 19, the right half portion 430 includes a triangularly shaped top wall member 452A and a triangularly shaped bottom wall member 453A that are integrally joined together by a generally rectangular shaped sidewall member 454. The sidewall member 454 at its proximal end 458A cooperates with the top wall member 452A and the bottom wall member 453A to form a U-shaped trough that is dimensioned to be received in a friction tight fit over half a reaching tool shaft, such as half of shaft 421 forming part of the reaching tool 420.

The top wall member 452A has two straight edge portions 470A and 471A and a curved edge portion 472A. Each of the edge portions 470A-472A have an identical thickness dimension T that is chosen to facilitate constraining the flexible finger members 422 and 424 so that their weight lifting capacity is increased at least 300% when constrained by the cuff 450. In addition, with the cuff 450 attached to the reaching tool 450, the fingers 422 and 424 are able to grab thin and heavy objects as well as wide heavy object, which would otherwise not be possible without the cuff 450. The thickness dimension T is also chosen to be sufficiently thick to support from the edge portion 471A a set of spaced apart rectangularly shaped tabs 466-468 that extend outwardly from the top wall edge 471A. The tabs 466-468 are dimensioned to be received in a set of slots 476-478 respectively that are disposed in a corresponding top wall edge 471B of the left portion 432.

The bottom wall member 453A in a similar manner to top wall member 452A has two straight edge portions 480A and 481A and a curved edge portion 482A. Each of the edge portions 480A-482A have an identical thickness dimension T that is chosen to facilitate constraining the flexible finger members 422 and 424 so that their weight lifting capacity is increased at least 300% when constrained by the cuff 450. The thickness dimension T is also chosen to be sufficiently thick to provide in the bottom wall edge 481 a set of spaced apart rectangularly shaped slots having the same dimensions as the slots 476-478 as illustrated in the top wall edge 471B of the left portion 432. The slots in the bottom wall edge 481A are dimensioned to receive a set of tabs 486-488 respectively that are disposed in a corresponding bottom wall edge 481B of the left portion 432.

As best seen in FIGS. 18-19, individual tabs, such as the tab 486 are coated with a fast acting adhesive, indicated generally at 490. The adhesive 490 is provided on the top surface and the bottom surface of each tab. In order to protect the adhesive layer until the time of assembling the kit 410, a transparent protection strip 492 extends over the top and bottom surfaces of the tabs, such as the tabs 486, 487 and 488.

Considering now the method of assembling the modification kit 410 in greater detail with reference to FIGS. 18-21, a user grasps either the right hand portion 430 or the left hand portion 432 and removes the protective strip 492 from its corresponding tabs. For example as best seen in FIG. 19, the user is illustrated as removing the strip 492 from the tabs 486-488. This process is then repeated for the other portion of the cuff 450.

Next the user grasps either the right hand portion 430 or the left hand portion 432 and mount it to the distal end of the shaft 421. For example, as best seen in FIG. 20, the user is illustrated as mounting the right hand portion 430 to the distal end of the reaching tool 420. In the regard, the U-shaped trough 458A is received on the shaft 421 in a snug friction tight fit. This process is then repeated for the other portion of the cuff 450 as best seen in FIG. 21. In this regard, as the right portion 430 and the left portion 432 are brought together their respective tabs and slots are aligned and pushed into engagement. The right portion 430 and the left portion 432 are pushed together and held for a few moments to allow the adhesive 490 to set and thereby fix the right portion 430 and the left portion 432 together.

Once the adhesive 490 has set the cuff 450 is permanently attached to the reaching tool 450 and now can constrain the bowing of the spring fingers 422 and 424 to channel and increase their weight lifting capacity.

Although in the preferred embodiment of the kit 410, the tabs are described as having an adhesive coating, it is contemplated within the true scope and spirit of the present invention, that the tabs may also have bosses and that the slots can include recesses to permit the tabs to snap and lock into place within the slots without the utilization of an adhesive.

Although in the preferred embodiment of the reaching tool modification kits 10, 110, 210 and 410 the kits are described as including a reaching tool, it should be understood by those skilled in the art that the kits could be provided without the reaching tool. In this regard, the constraining cuffs and their respective attachment means can be provided as an after market kit that can be easily utilized and attached to a pre-existing reaching tool. It should also be understood by those skilled in the art, the cuffs 50, 150 250, 350 and 450 can be attached to a reaching tool in a fast and convenient manner.

While the invention has been described with reference to a particular embodiment thereof, those skilled in the art will be able to make various modifications to the described embodiment of the invention without departing from the true spirit and scope thereof. For example, in FIG. 16, there is illustrate a modified cuff 350 which includes a plurality of bosses, such as the boss grouping 352 and the boss grouping 354, and positioning pins 356 and 358 respectively. Accordingly, it is intended that all combinations of elements and steps, which perform substantially the same function in substantially the same way to achieve substantially the same results, are within the scope of this invention.

I claim:

1. A modification kit for a reaching tool having elongated flexible jaw members extending outwardly from a distal end portion of a shaft, said modification kit comprising:
cuff means removably mounted to the shaft for constraining outward bowing of the elongated jaw member to facilitate substantially increasing the weight-lift capacity of the reaching tool.

2. A modification kit according to claim 1, wherein said cuff means includes interior capture means for constraining the movement of the jaw members within an interior portion of said cuff means.

3. A modification kit according to claim 1, wherein said cuff means includes securing means for attaching said cuff means to the reaching tool.

4. A method of increasing the weight lifting capacity of a reaching tool having shaft with a pair of flexible elongated spring fingers extending therefrom for grasping an object, comprising:
providing a constraining cuff having a large front mouth opening and a small rear mouth opening;
moving the spring fingers into engagement with one another;
receiving the engaged spring fingers within said small rear mouth opening;
releasing the spring fingers from their engagement with one another; and
pushing said constraining cuff rearward a sufficient distance to bring said small rear mouth opening into friction tight engagement with the shaft of the reaching tool and to permit a sufficient portion of the spring finger to protrude out of said front mouth a sufficient distance to position the spring fingers in their fully open position for grasping the object.

5. The method of claim 4 further comprising:
inserting positioning pins in said constraining cuff to removably secure it to the reaching tool.

6. A modification kit for a reaching tool having a pair of elongated flexible spring fingers pivotally secured to a shaft and adapted to move toward one another to facilitate grasping an object, the modification kit comprising:
a cuff having a sufficient interior space to receive and support therein a substantial portion of the spring fingers;
said cuff further having a front mouth and a rear mouth wherein said rear mouth is dimensioned to engage in a friction tight fit the shaft to facilitate supporting said cuff from the shaft;
wherein said cuff sufficiently restrains outward bowing of the spring fingers when the are moved towards one another for engaging an object to substantially increase the weight load capacity of the reaching tool.

7. The modification kit of claim 6, wherein said cuff is funnel shaped.

8. The modification kit of claim 7, wherein the cuff has a unitary construction.

9. The modification kit of claim 8, wherein the cuff is formed from molded plastic.

10. The modification kit of claim 8, wherein said cuff is a flat sheet of plastic having a plurality of plastic hinges and a plurality of snap hook arrangements to facilitate folding and securing said sheet of plastic into a funnel shaped container.

11. The modification kit of claim 6, wherein said cuff includes a top wall member and a bottom wall member spaced from one another by a sidewall member and integrally connected together by a pair of plastic hinges extending along a pair of opposite sides of said sidewall member; and
wherein said top wall member and said bottom wall member each include a pair of pin alignment holes, wherein the pair of pin alignment holes in said top wall member are in perpendicular alignment with the pair of alignment holes in said bottom wall member; and wherein
said pair of alignment holes in said top wall member and said pair of alignment holes in said bottom wall member are spaced rearward of said rear opening and are each dimensioned for receiving therein in a friction tight fit a positioning pin for securing and positioning said cuff to said reaching tool.

12. The modification kit of claim 9, wherein a least one of said top wall member and said bottom wall member includes a pair of spaced apart interior restraining walls, each individual one of the interior restraining walls being spaced a sufficient distance from an associated one of said sidewall members to facilitate capturing therebetween a portion of one of said spring fingers to help prevent its outward bowing.

13. The modification kit of claim 10, wherein said top wall member and said bottom wall member each include a pair of pin alignment holes, wherein the pair of pin alignment holes in said top wall member are in perpendicular alignment with the pair of alignment holes in said bottom wall member; and wherein
said pair of alignment holes in said top wall member and said pair of alignment holes in said bottom wall member are spaced rearward of said rear opening and are each dimensioned for receiving therein in a friction tight fit a positioning pin,
said positioning pin having a sufficient length to further secure said cuff to said reaching tool.

14. The modification kit of claim 8, wherein the cuff includes a top wall member and a bottom wall member, said top wall member and said bottom wall member being integrally connected to one another by a pair of sidewall members.

15. A reaching tool kit, comprising:
a reaching tool having a pair of elongated flexible spring fingers pivotally secured to a shaft and adapted to move toward one another to facilitate grasping an object;
a cuff having a sufficient interior space to receive and support therein a substantial portion of the spring fingers;
said cuff further having a front mouth and a rear opening wherein said rear opening is dimensioned to engage in a friction tight fit the shaft to facilitate supporting said cuff from the shaft;
wherein said cuff sufficiently restrains outward bowing of the spring fingers when the are moved towards one another for engaging an object to substantially increase the weight loading capacity of the reaching tool.

16. The reaching tool kit according to claim 15, wherein the reaching tool includes:
an elongated hollow stalk terminating at spaced-apart distal and proximal ends, said spring fingers extending divergently outward from said distal end of said stalk and including flexible elements terminating the outer ends of said fingers for grasping an object when brought toward one another;
a center strap extending from one of said fingers interiorly along said stalk and then back interiorly to the other one of said fingers;
a handle formed in cooperation with said stalk including a handle member pivotally mounted to said stalk and further including means for drawing said center strap rearward said fingers when said handle member is pivoted toward said stalk; and
a first hollow stalk plug for slideable insertion in said distal end of said stalk for retaining said fingers by friction in mounted position in said stalk.

17. The reaching tool kit of claim 15, wherein said cuff is funnel shaped.

18. The reaching tool kit of claim 17, wherein the cuff has a unitary construction.

19. The reaching tool kit of claim 18, wherein the cuff includes a top wall member and a bottom wall member, said top wall member and said bottom wall member being integrally connected to one another by a pair of sidewall members.

20. The modification kit according to claim 18, wherein said cuff is formed from a metallic material.

21. A cuff for restricting and channeling the weight-lifting power of a reaching tool having elongated flexible jaw members extending outwardly from a distal end portion of a shaft, said cuff comprising:
a funnel shaped enclosure having a large front mouth opening and a small rear mouth opening;
said enclosure having a sufficiently small interior area for constraining outward bowing of the elongated jaw member to facilitate substantially increasing the weight-lift capacity of the reaching tool.

22. The cuff of claim 21, wherein said funnel shaped enclosure is formed from a unitary sheet of plastic that folds around the jaw members to constrain their outward bowing when lifting an object.

23 The cuff of claim 21, wherein said funnel shaped enclosure is a metallic enclosure.

24. The cuff of claim 21, wherein said funnel shaped enclosure is a plastic enclosure.

25. The cuff of claim 24, wherein the plastic enclosure includes a pair of a plurality of spaced apart bosses for facilitating mounting the cuff to the reaching tool.

26. The cuff of claim 24, wherein the plastic enclosure includes a pair of mounting holes dimensioned to receive in a friction tight fit a corresponding pair of mounting pins for facilitating mounting the cuff to the reaching tool.

27. The cuff of claim 25, wherein the plastic enclosure further includes a pair of mounting holes dimensioned to receive in a friction tight fit a corresponding pair of mounting pins for further facilitating the mounting of the cuff to the reaching tool
